(19) United States
(12) Patent Application Publication
(10) Pub. No.: US 2026/0051571 A1
(43) Pub. Date: Feb. 19, 2026

(54) BATTERY HEATING DURING VEHICLE MOTION

(71) Applicant: GM GLOBAL TECHNOLOGY OPERATIONS LLC, Detroit, MI (US)

(72) Inventors: Renato Amorim Torres, Pontiac, MI (US); Neeraj S. Shidore, Novi, MI (US); Suresh Gopalakrishnan, Troy, MI (US); Chandra S. Namuduri, Troy, MI (US); Lei Hao, Troy, MI (US); Vinod Chowdary Peddi, Shelby Township, MI (US); Satish P. Ketkar, Troy, MI (US)

(73) Assignee: GM GLOBAL TECHNOLOGY OPERATIONS LLC, Detroit, MI (US)

(21) Appl. No.: 18/803,286

(22) Filed: Aug. 13, 2024

(51) Int. Cl. H01M 10/667; B60L 50/51; B60L 50/60; H01M 10/615; H01M 10/625

(52) U.S. Cl. CPC H01M 10/667; B60L 50/51; B60L 50/60; H01M 10/615; H01M 10/625; B60L 2210/40

(57) ABSTRACT

A battery heating system including an inverter for transforming a DC current into a first AC current having a first phase, a second AC current having a second phase, and a third AC current having a third phase, a battery for supplying the DC current to the inverter and wherein an AC component is superimposed on the DC current and wherein the battery is heated in response to the AC component via ohmic losses, and a three phase electric motor configured to generate an electromagnetic torque having a quadrature component and a direct component in response to the first AC current, the second AC current and the third AC current wherein the inverter is configured to adjust the first phase, the second phase and the third phase resulting in the direct component having a non-zero magnitude and the quadrature component such that the electromagnetic torque has a zero magnitude.

### INTRODUCTION

The present disclosure generally relates to electric vehicle motors and battery systems, and more particularly relates to a method and apparatus to allow battery internal heating while a vehicle is in motion in response to an AC component in battery current resultant from an electric motor generating an electromagnetic torque resultant from a non-zero direct current component and a quadrature current component having a zero or non-zero magnitude.

Electric motors are used in electric vehicles (EV) to convert electrical energy from the battery into mechanical energy to turn the wheels. Typically, there are two main types of electric motors used in EVs: induction motors and permanent magnet synchronous motors (PMSMs). Induction motors are the most common type of electric motor used in EVs. They are relatively simple and inexpensive to manufacture. Induction motors are also very efficient, and they can provide a high torque output. PMSMs are more expensive than induction motors, but they are also more efficient and offer better performance. PMSMs are often used in high-performance EVs, such as sports cars and racing cars. Modern EVs typically have two electric motors, one for each axle, but some EVs can have a single motor located under the hood or four motors, one for each wheel.

In EVs, ensuring the battery pack operates within an optimal temperature window is critical for maximizing performance, longevity, and safety. Just like extreme engine heat can damage a traditional gasoline car, excessively cold temperatures significantly hinder an EV battery's capabilities. Cold batteries suffer from reduced power output and struggle to accept a charge efficiently. Pre-heating the battery in cold weather addresses this challenge by bringing it up to a functional temperature range. For the same reasons, it is desirable to maintain a battery temperature within this optimal temperature window throughout all stages of vehicle operation. This optimization ensures the battery can deliver its full potential, mitigating potential range reduction. Electric vehicle charging has improved through expanded charging station networks, faster charging speeds, and increasing integration with renewable energy sources. By proactively managing battery temperature, EVs can safeguard the health of this vital component and foster a consistent, reliable driving experience regardless of the outside climate. It is desirable to efficiently provide battery heating and cooling during vehicle operation to ensure the battery temperature remains within the optimal temperature window and to use energy as efficiently as possible to reduce any energy waste in order to provide systems and methods for vehicle propulsion and driver assistance systems. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle control methods and systems and related electrical systems for provisioning vehicle propulsion systems, methods for making and methods for operating such systems, and motor vehicles and other equipment such as aircraft, trucks, buses, forklifts, construction vehicles and other electric vehicles equipped with battery powered electric motors. By way of example, and not limitation, there are presented various embodiments of systems for AC heating of a battery in response to a resultant AC current superimposed on a DC component from the battery when an electromagnetic force is generated by an electric motor having a non-zero direct component and the quadrature component having a zero or non-zero magnitude.

In accordance with an aspect of the present disclosure, a battery heating system including an inverter for transforming a DC current into a first AC current having a first phase, a second AC current having a second phase, and a third AC current having a third phase, a battery for supplying the DC current to the inverter and wherein an AC component is superimposed on the DC current and wherein the battery is heated in response to the AC component via ohmic losses, and a three phase electric motor configured to generate an electromagnetic torque having a quadrature component and a direct component in response to the first AC current, the second AC current and the third AC current wherein the inverter is configured to adjust the first phase, the second phase and the third phase resulting in the direct component having a non-zero magnitude and the quadrature component such that the electromagnetic torque has a zero magnitude.

In accordance with an aspect of the present disclosure, wherein the first AC current, the second AC current and the third AC current are mapped as a two axis reference frame rotating at a synchronous speed of the three phase electric motor with the direct component being aligned with a magnetic field of the three phase electric motor and the quadrature component having a perpendicular alignment to the magnetic field of the three phase electric motor.

In accordance with an aspect of the present disclosure, wherein the inverter is further operative to control a plurality of transistor switching control signals to produce the AC component in the direct component and minimize the quadrature component.

In accordance with an aspect of the present disclosure, wherein the direct component and the quadrature component are estimated in response to a Park transform output.

In accordance with an aspect of the present disclosure, wherein the battery is heated internally via ohmic losses in response to the AC component superimposed on the DC current of a battery current.

In accordance with an aspect of the present disclosure, wherein the inverter is further operative to control a plurality of transistor switching control signals applied to a plurality of switching transistors such that the direct component has the AC component and the quadrature component is defined by a requirement that the electromagnetic torque follows a constant torque curve.

In accordance with an aspect of the present disclosure, wherein a magnitude of the AC component superimposed on the DC current is proportional to the AC component of the direct component.

In accordance with an aspect of the present disclosure, wherein the first AC current, the second AC current and the third AC current are adjusted to generate a non-zero magnitude of the quadrature component such that the electromagnetic torque has a non-zero magnitude and the AC component superimposed on the DC current has a non-zero magnitude.

In accordance with an aspect of the present disclosure, wherein a switching of the inverter is controlled using a voltage feedforward method.

In accordance with an aspect of the present disclosure, a method of providing an AC battery heating for vehicular applications including generating, by an inverter, a first AC current having a first phase, a second AC current having a second phase, and a third AC current having a third phase in response to a DC current from a battery, generating, by an electric motor, an electromagnetic torque having a quadrature component and a direct component in response to the first AC current, the second AC current and the third AC current, generating an AC component superimposed on the DC current in response to the direct component and the quadrature component, adjusting, by the inverter, the first phase, the second phase and the third phase such that the direct component has a non-zero magnitude and the quadrature component such that the electromagnetic torque has a zero magnitude, and heating the battery in response to the AC component superimposed on the DC current.

In accordance with an aspect of the present disclosure, wherein the AC component is proportional to a magnitude of the quadrature component and the direct component.

In accordance with an aspect of the present disclosure, wherein the electromagnetic torque is mapped as a two axis reference frame rotating at a synchronous speed of the electric motor with the direct component being aligned with a magnetic field of the electric motor and the quadrature component having a perpendicular alignment to the magnetic field of the electric motor.

In accordance with an aspect of the present disclosure, wherein an amplitude of the first AC current, an amplitude of the second AC current and an amplitude of the third AC current are adjusted to maximize a magnitude of the quadrature component and to minimize a magnitude of the direct component.

In accordance with an aspect of the present disclosure, wherein the direct component and the quadrature component are estimated in response to a Park transform output.

In accordance with an aspect of the present disclosure, wherein the inverter is further operative to control a plurality of transistor switching control signals applied to a plurality of switching transistors such that a d-axis current and a q-axis current follows a constant torque curve.

In accordance with an aspect of the present disclosure, wherein the magnitude of the direct component is proportional to the AC component superimposed on the DC current.

In accordance with an aspect of the present disclosure, wherein the inverter is further operative to control a plurality of transistor switching control signals applied to a plurality of switching transistors such that the direct component and the quadrature component follows a constant torque curve.

In accordance with an aspect of the present disclosure, wherein a switching of the inverter is controlled using a voltage feedforward method.

In accordance with an aspect of the present disclosure, a vehicle propulsion system including a three phase electric motor configured to generate an electromagnetic torque having a direct component and a quadrature component, an inverter for transforming a DC current into a first AC current having a first phase, a second AC current having a second phase, and a third AC current having a third phase, and a battery for supplying the DC current to the inverter and wherein an AC component is superimposed on the DC current and wherein the battery is heated in response to the AC component via ohmic losses wherein the inverter is configured to adjust the first phase, the second phase and the third phase resulting in the direct component having a non-zero magnitude and the quadrature component such that the electromagnetic torque has a zero magnitude.

In accordance with an aspect of the present disclosure, wherein the direct component and the quadrature component are estimated in response to a Park transform output, and wherein a magnitude of the direct component is proportional to the AC component superimposed on the DC current, and wherein the first AC current, the second AC current and the third AC current are adjusted to generate a non-zero magnitude of the quadrature component such that the electromagnetic torque has a non-zero magnitude and the AC component has a non-zero magnitude.

### BRIEF DESCRIPTION OF THE DRAWINGS

The exemplary embodiments will hereinafter be described in conjunction with the following drawing figures, wherein like numerals denote like elements, and wherein:

FIG. 1 shows an exemplary EV propulsion system in accordance with various embodiments;

FIG. 2 shows a schematic representation of an EV propulsion system;

FIG. 3 shows a graph illustrative of exemplary Id and Iq current components required to maintain constant torque while generating AC current in the battery in accordance with various embodiments; and

FIG. 4 shows a graph illustrative of a torque curve time varying Id current and time varying Iq current in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

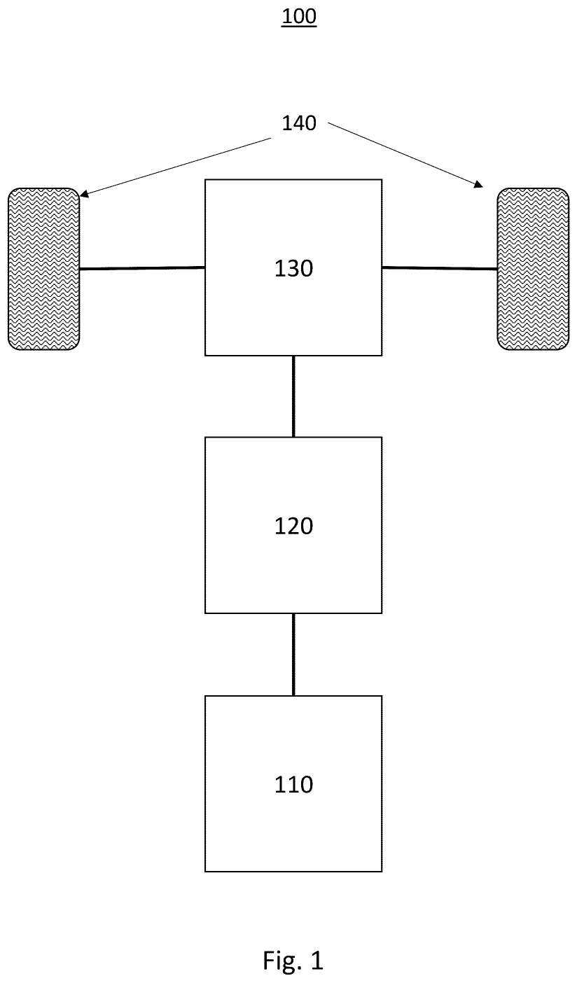

With reference to FIG. 1, an exemplary EV propulsion system 100 in accordance with various embodiments is shown. In general, the EV propulsion system 100 can include a battery 110, an inverter 120, an electric motor 130 and a plurality of wheels 140.

The energy source for an EV is the battery 110, a high-fidelity energy storage system designed for robust power delivery to the electric motor 130. Unlike traditional internal combustion engines fueled by gasoline, EVs rely on these rechargeable batteries 110. Each battery 110 can be configured from numerous lithium-ion cells strategically connected in series and parallel configurations to achieve the desired output voltage and capacity. The battery 110 functions through a well-defined electrochemical process occurring between the anode and cathode. The positive anode, typically comprised of lithium cobalt oxide (LiCoO2), and the negative graphite cathode harbor the key for generating electricity. During discharge, lithium ions shuttle between the electrodes, flowing from the anode to the cathode. This movement of ions is accompanied by a corresponding flow of electrons through an external circuit, ultimately powering the electric motor 130. To reverse this process and replenish the battery's energy reserves, the EV is plugged into a charging station. Electrons from the charger flow in the opposite direction, causing lithium ions to migrate back to the anode. This meticulously controlled flow of ions and electrons defines the charging and discharging cycles that the battery 110 performs throughout its operational lifespan.

Ensuring the efficient and safe operation of the battery 110 is the responsibility of the battery management system (BMS). This sophisticated computer system acts as the guardian of the battery pack, meticulously regulating factors like cell voltage, current, and temperature. By meticulously monitoring these parameters, the BMS optimizes battery performance, extends its useful life, and prioritizes safety. It achieves this by constantly balancing the voltages across individual cells within the pack, preventing any from experiencing overcharging or over-discharging conditions that could lead to damage. Furthermore, the BMS serves as a vital communication hub, relaying real-time data on battery health and remaining range to the vehicle's onboard diagnostics system. This information is crucial for the driver to make informed decisions regarding charging needs and optimize their travel experience.

Within an EV propulsion system 100, the DC-AC inverter 120 acts as a critical interface between the high-voltage battery 110 and the electric motor 130. The inverter 120 is configured to efficiently convert the DC output from the battery 110 into a precisely controlled, three-phase AC current to be supplied to the electric motor 130. Employing power devices such as insulated-gate bipolar transistors (IGBTs) or metal-oxide-semiconductor field-effect transistor (MOSFET) in a pulse-width modulation (PWM) scheme, the inverter 120 synthesizes the desired AC waveforms. This three-phase AC output is characterized by three sinusoidal waveforms, each offset by 120 degrees relative to the others. This strategic manipulation by the inverter 120 is crucial as it engenders a rotating magnetic field within the electric motor 130. The configuration of the switching sequence dictates the rotational speed and torque of the motor 130 to enable smooth and efficient vehicle operation.

In some exemplary embodiments, the inverter 120 leverages high-performance power devices (such as IGBTs or MOSFETS) as the core building blocks, while gate driver circuits and advanced control algorithms ensure their precise and efficient operation. A sensor suite can be employed to monitor voltage and current changes within the system, feeding real-time data to the BMS. This continuous feedback loop facilitates ongoing adjustments and optimizations, guaranteeing the inverter operates at peak efficiency across diverse driving conditions. In addition, thermal management plays a crucial role in maximizing inverter efficiency. The design can use low-resistance materials and high-switching speed to minimize internal energy losses. During regenerative braking, the inverter 120 can be employed to recapture kinetic energy from the vehicle's deceleration and transforms this energy back into DC power, effectively replenishing the battery 110. This regenerative energy conversion enhances overall driving range and illustrates the bidirectional function of the inverter 120 in the EV propulsion system 100.

Leveraging the principles of electromagnetism, the electric motor 130 can be an induction motor or a permanent magnet synchronous motor (PMSM) having high efficiency and power density. Unlike internal combustion engines, the PMSM transforms electrical energy stored in the DC battery pack via the inverter 120 into mechanical rotation to propel the vehicle. The electric motor 130 is comprised of two key components: the stator and the rotor. The stator is a fixed, cylindrical shell that houses strategically placed permanent magnets. Encapsulating the stator is the rotor, a rotating shaft constructed from laminated steel segments. Embedded within these segments are windings, meticulously crafted coils of conductive material. The interplay between the three-phase AC current supplied by the inverter 120 and the permanent magnets in the stator induces a current within the windings of the rotor. This induced current produces a reciprocal magnetic field around the rotor. The resulting interaction between these two magnetic fields exerts a torque on the rotor, causing it to spin continuously in the direction of the rotating magnetic field generated by the stator. Controlling the frequency and voltage of the three AC phases delivered by the inverter 120, regulates the speed and torque of the electric motor 130. This granular control ultimately dictates the vehicle's acceleration and overall performance.

Leveraging the existing electric motor 130 for in-vehicle battery heating presents a challenge while optimizing thermal management in the EV propulsion system 100. While current implementations demonstrate the viability of battery heating during stationary charging, extending this functionality to on-the-go scenarios unlocks significant advantages for the development of a more dynamic and efficient battery thermal management system. Providing dedicated heating current generation by isolating a portion of the electric drive's capacity allows for the generation of AC current specifically dedicated to battery heating. This isolated operation ensures that the heating process wouldn't directly compete with propulsion needs, maintaining vehicle performance.

The rotational force generated by the electric motor 130 is typically directly proportional to the current and magnetic field strength. However, to achieve optimal vehicle performance, this output speed typically needs further tailoring using a torque transfer system. In some exemplary embodiments, a reduction gear set acts as a crucial intermediary, functioning as a speed multiplier. This gearbox translates the high-speed, low-torque output of the motor into a lower-speed, high-torque output ideally suited for driving the wheels. This vital gear reduction enables the motor to operate within its most efficient range while simultaneously providing the substantial torque required to overcome vehicle inertia, rotate each of the plurality of wheels 140 and propel the vehicle forward.

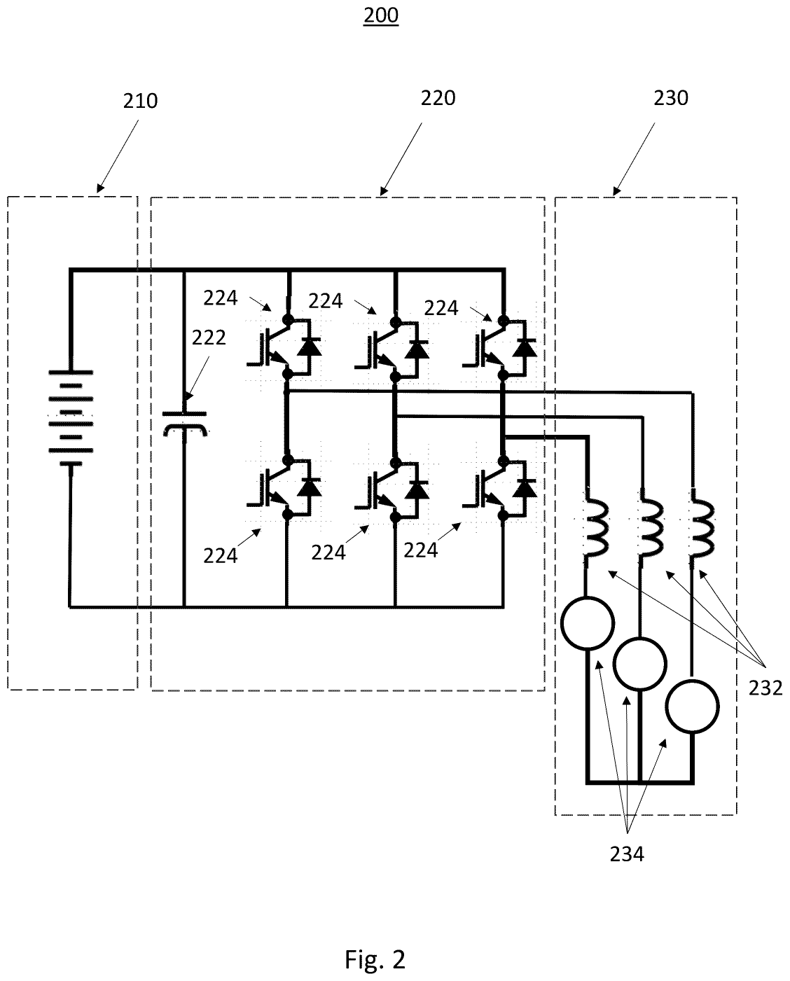

Turning now to FIG. 2, a schematic representation of an EV propulsion system 200 is shown. The schematic is representative of the battery 210, the inverter 220 and the drive motor 230. The battery 210 is configured to provide DC power to the inverter circuitry 220. The inverter 220 is configured to receive the DC power from the battery 210 and to transform the DC power into a three-phase AC current required by the electric motor 230. The inverter 220 rapidly switches the plurality of power switching devices 224, such as transistors, in a predetermined sequence, generating a pulsating DC output. In some exemplary embodiments, filters, such as a decoupling capacitor 222 placed between the power and ground pins of the inverter 220, to filter out noise and maintain stable power supply voltage during switching, or one or more load capacitors or inductors to remove unwanted harmonics, resulting in a clean, three-phase AC waveform at the inverter 220. Each phase carries a distinct AC current, meticulously orchestrated to create a rotating magnetic field within the motor. Each of the windings 232 in the stators of the drive motor 230 are connected to one of these three phases currents. As the current flows through the windings 232, it creates a magnetic field. The interaction of the three phase-shifted currents produces a rotating magnetic field.

In the drive motor 230, the rotating magnetic field from the stators interact with the windings or the magnets in the rotor of the drive motor 230. This interaction induces a current in the rotor windings 232, which in turn creates a force according to Lenz's Law. This force causes the rotor to try and align itself with the rotating magnetic field, resulting in continuous rotation of the motor shaft. This rotating field is the driving force behind the motor shaft's rotation, ultimately propelling the vehicle forward. The inverter's control system allows for precise manipulation of the AC output's frequency and voltage. This fine-tuned control enables the system to precisely regulate the motor's speed and torque, ensuring smooth, efficient, and optimized operation of the EV. When in operation, the drive motor can generate back electro-motive force (BEMF) 234 which is a voltage which is opposite in polarity, created by the rotation of a coil in a magnetic field. For example, the continued rotation of the motor shaft by the wheels induces BEMF in the stator windings due to the relative motion between the permanent magnets and the windings. During motoring operation, this BEMF inherently opposes the current supplied by the battery 210 and the inverter 220. During regenerative operation, this BEMF inherently develops current in the battery 210 and the inverter 220. Thus, the inverter 220 can actively convert the induced BEMF, which is in the form of AC current, into DC current that can directly recharge and heat the battery 210.

Maintaining tight thermal control of the battery 210 during electric vehicle operation is crucial to ensure optimal battery health, extended lifespan, and enhanced safety. A well-defined thermal window, often around 0-35° C., maximizes battery performance. Exceeding this range triggers detrimental chemical reactions that accelerate capacity fade, impacting driving range and potentially escalating safety risks through thermal runaway, a catastrophic self-heating scenario. Conversely, low temperatures cripple power delivery and charging efficiency. Therefore, a robust thermal management system becomes an indispensable engineering solution. Advantageously, the electric motor 230 can be used in conjunction with the inverter 220 to generate an electric current to be used to heat the battery 210 during electric vehicle operation. It is desirable to provide battery AC heating while the vehicle is in motion. This can involve AC heating current generation using electric drive that is not contributing to torque, AC heating current generation using electric drive that also contributes to torque or both. The inverter circuitry 220 is configured to induce unbalanced three phase currents in the electric motor. The unbalanced currents draw a non-constant current from the DC-link that creates a voltage swing in the DC-link inducing an AC current in the battery.

Within the context of Field-Oriented Control (FOC) for three-phase AC motors, Id and Iq represent derived current components obtained through a mathematical transformation, such as Clarke and Park transforms, of the measured stator currents. These transformed currents reside in a rotating reference frame synchronized with the rotor's magnetic field, where Id on the d-axis controls the motor's magnetic flux and thus torque generation capability, while Iq on the q-axis directly dictates the developed torque. By independently manipulating Id and Iq, superior control can be achieved over the drive motor's speed and torque characteristics, optimizing efficiency and performance across a wide range of operating conditions in variable-speed drive applications. During operation, it can be desirable to generate an AC current component superimposed on the DC current component from the battery. This AC current component can generate heat within the battery 210 due to ohmic losses. In addition, the phase and magnitude of each of the AC currents generated by the inverter 220 to apply to the electric motor 230 can be adjusted such that the direct component of the current in the electric motor 230 has a non-zero magnitude and the amplitude of the quadrature component such that the electromagnetic torque has a zero magnitude. Thus, the AC current component used for battery heating can be generated without a net torque being applied to the electric motor 230.

In a first exemplary embodiment, a vehicle with more than one electric motor can be propelled by a first motor, while battery AC current generation is provided by another motor that does not produce any torque. In this case, in the AC current component used for battery heating results from non-zero alternating direct current components within the electric motor 230 and zero quadrature current component resulting in a zero magnitude quadrature component and no net torque. In a second exemplary embodiment, the same drive motor that is producing torque also generates battery AC current for heating the battery 210. In some exemplary embodiments, Id injection can be biased towards regions where noise vibration and harshness (NVH) is lower. Bias can move depending on machine speed to obey voltage limit ellipse. In some embodiments, trajectory can be modified based on demanded torque and current limit circle.

In some exemplary embodiments, motor control strategies can be employed to allow battery AC heating while vehicle is in motion. AC heating current can be generated using an electric drive that is not contributing to torque or an electric drive that also contributes to torque. Heat distribution among machines may be based on loss minimization or best possible system efficiency, and can be implemented based on apriori look up tables or optimization techniques, such as a function of road load, or battery heating rate, for example. The AC heating ratio between electric motors can be varied depending on the maximum motor/inverter temperatures.

Several methods are available to control the performance of motor drives to provide the AC heating current. The basic voltage feedforward approach offers a straightforward solution, but for more demanding applications, a high bandwidth controller combined with voltage feedforward can provide improved regulation. Additionally, resonant controllers can be employed for specific operating conditions where precise control at the frequency of the injected AC signal is crucial.

For applications requiring battery heating, closed-loop or open-loop control strategies can be implemented for AC current injection. A hybrid approach combining both methods offers further flexibility. Notably, the d-axis current injection can be strategically biased towards regions with lower Noise, Vibration, and Harshness (NVH) levels. This bias can also be adjusted dynamically based on motor speed to ensure adherence to voltage limit constraints.

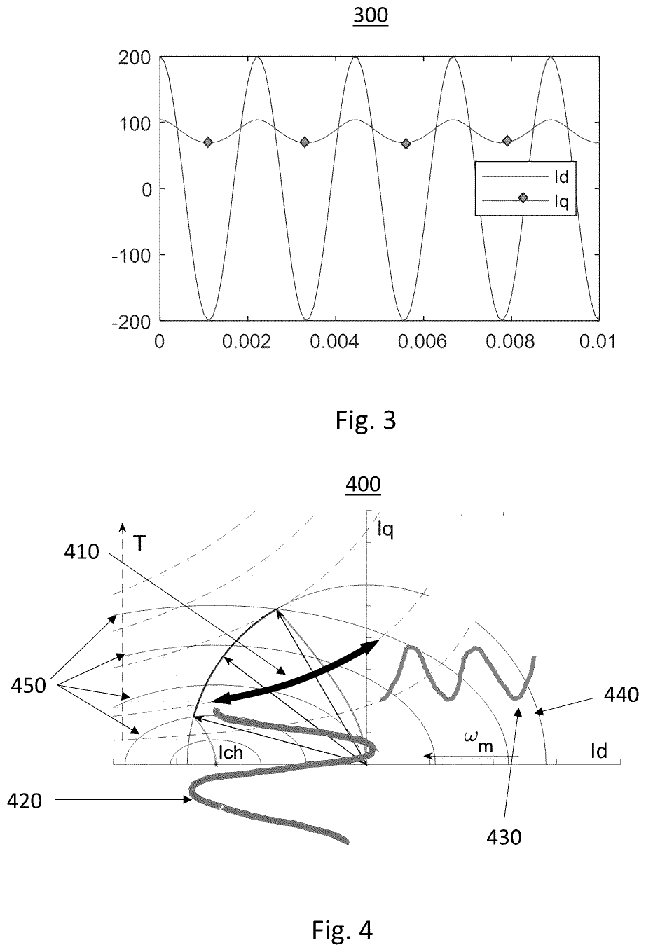

Turning now to FIG. 3, a graph 300 is presented illustrative of exemplary Id and Iq components required to maintain constant torque while generating AC current in the battery.

Supervisory control plays a key role in maximizing AC heating by optimizing torque distribution across multiple motors. The control system can dynamically adjust the trajectory of the (Id, Iq) pair, transitioning between constant torque curves to meet the required torque demands and zero torque to meet the battery heating demands without a torque component. This dynamic control strategy ensures efficient operation while achieving optimal heating performance. In some exemplary embodiments, the control strategy where current commands for Id and Iq are obtained via (Id, Iq) pair that is always sweeping the constant torque curve are defined by the following equation.

$${i}_{q} = \frac{2 {T}_{e}}{3 p ( {λ}_{PM} + ( {L}_{ds} - {L}_{qs} ) {i}_{d} )} .$$

The equation described an exemplary control strategy for permanent magnet synchronous motors (PMSMs) used in electric vehicles. It describes the relationship between the current on the d-axis (Id) and the current on the q-axis (Iq) to achieve a constant torque (Te). Wherein:
Id: current on the d-axis
Iq: current on the q-axis
Te: electromagnetic torque
p: number of pole pairs
λ_{PM}: permanent magnet flux linkage
Lds: d-axis inductance
Lqs: q-axis inductance

The equation shows that the current on the q-axis (Iq) is proportional to the electromagnetic torque (Te) and inversely proportional to several factors including the number of pole pairs (p), the permanent magnet flux linkage (λ_{PM}), and the difference between the d-axis inductance (Lds) and the q-axis inductance (Lqs). The factor (Lds−Lqs) is sometimes referred to as the saliency of the motor.

Turning now to FIG. 4, a graph 400 is presented illustrative of a torque curve 410 time varying Id current 420 and time varying Iq current 430. The resulting torque curve 410 is constant and the Id, Iq current pair is always sweeping the constant torque curve, assuming constant torque demand. In some exemplary embodiments, a projection of the sinusoidal curve Id current 420 on the torque curve 410 we can calculate the required current Iq 430 using the above equation. Other methods can be used to define Id and Iq currents that obey the equation above. The current line circle 440 indicative of the current limit of the drive is further illustrated. The synthesized Id and Iq currents should stay within the current line circle 440 limit. The ellipses 450 are indicative of the drive voltage limits for different mechanical speeds so that the synthesized Id and Iq currents should stay within these limits.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery heating system for vehicular applications comprising:
an inverter for transforming a DC current into a first AC current having a first phase, a second AC current having a second phase, and a third AC current having a third phase;
a battery for supplying the DC current to the inverter and wherein an AC component is superimposed on the DC current and wherein the battery is heated in response to the AC component via ohmic losses; and
a three phase electric motor configured to generate an electromagnetic torque having a quadrature component and a direct component in response to the first AC current, the second AC current and the third AC current wherein the inverter is configured to adjust the first phase, the second phase and the third phase resulting in the direct component having a non-zero magnitude and the quadrature component such that the electromagnetic torque has a zero magnitude.

2. The battery heating system for vehicular applications of claim 1, wherein the first AC current, the second AC current and the third AC current are mapped as a two axis reference frame rotating at a synchronous speed of the three phase electric motor with the direct component being aligned with a magnetic field of the three phase electric motor and the quadrature component having a perpendicular alignment to the magnetic field of the three phase electric motor.

3. The battery heating system for vehicular applications of claim 1, wherein the inverter is further operative to control a plurality of transistor switching control signals to produce the AC component in the direct component and minimize the quadrature component.

4. The battery heating system for vehicular applications of claim 1, wherein the direct component and the quadrature component are estimated in response to a Park transform output.

5. The battery heating system for vehicular applications of claim 1, wherein the battery is heated internally via ohmic losses in response to the AC component superimposed on the DC current of a battery current.

6. The battery heating system for vehicular applications of claim 1, wherein the inverter is further operative to control a plurality of transistor switching control signals applied to a plurality of switching transistors such that the direct component has the AC component and the quadrature component is defined by a requirement that the electromagnetic torque follows a constant torque curve.

7. The battery heating system for vehicular applications of claim 1 wherein a magnitude of the AC component superimposed on the DC current is proportional to the AC component of the direct component.

8. The battery heating system for vehicular applications of claim 1, wherein the first AC current, the second AC current and the third AC current are adjusted to generate a non-zero magnitude of the quadrature component such that the electromagnetic torque has a non-zero magnitude and the AC component superimposed on the DC current has a non-zero magnitude.

9. The battery heating system for vehicular applications of claim 1, wherein a switching of the inverter is controlled using a voltage feedforward method.

10. A method of providing an AC battery heating for vehicular applications comprising:
generating, by an inverter, a first AC current having a first phase, a second AC current having a second phase, and a third AC current having a third phase in response to a DC current from a battery;
generating, by an electric motor, an electromagnetic torque having a quadrature component and a direct component in response to the first AC current, the second AC current and the third AC current;
generating an AC component superimposed on the DC current in response to the direct component and the quadrature component;
adjusting, by the inverter, the first phase, the second phase and the third phase such that the direct component has a non-zero magnitude and the quadrature component such that the electromagnetic torque has a zero magnitude; and
heating the battery in response to the AC component superimposed on the DC current.

11. The method of providing the AC battery heating for vehicular applications of claim 10, wherein the AC component is proportional to a magnitude of the quadrature component and the direct component.

12. The method of providing the AC battery heating for vehicular applications of claim 10, wherein the electromagnetic torque is mapped as a two axis reference frame rotating at a synchronous speed of the electric motor with the direct component being aligned with a magnetic field of the electric motor and the quadrature component having a perpendicular alignment to the magnetic field of the electric motor.

13. The method of providing the AC battery heating for vehicular applications of claim 10, wherein an amplitude of the first AC current, an amplitude of the second AC current and an amplitude of the third AC current are adjusted to maximize a magnitude of the quadrature component and to minimize a magnitude of the direct component.

14. The method of providing the AC battery heating for vehicular applications of claim 10, wherein the direct component and the quadrature component are estimated in response to a Park transform output.

15. The method of providing the AC battery heating for vehicular applications of claim 10, wherein the inverter is further operative to control a plurality of transistor switching control signals applied to a plurality of switching transistors such that a d-axis current and a q-axis current follows a constant torque curve.

16. The method of providing the AC battery heating for vehicular applications of claim 10, wherein the magnitude of the direct component is proportional to the AC component superimposed on the DC current.

17. The method of providing the AC battery heating for vehicular applications of claim 10, wherein the inverter is further operative to control a plurality of transistor switching control signals applied to a plurality of switching transistors such that the direct component and the quadrature component follows a constant torque curve.

18. The method of providing the AC battery heating for vehicular applications of claim 10, wherein a switching of the inverter is controlled using a voltage feedforward method.

19. A vehicle propulsion system comprising:
a three phase electric motor configured to generate an electromagnetic torque having a direct component and a quadrature component;
an inverter for transforming a DC current into a first AC current having a first phase, a second AC current having a second phase, and a third AC current having a third phase; and
a battery for supplying the DC current to the inverter and wherein an AC component is superimposed on the DC current and wherein the battery is heated in response to the AC component via ohmic losses wherein the inverter is configured to adjust the first phase, the second phase and the third phase resulting in the direct component having a non-zero magnitude and the quadrature component such that the electromagnetic torque has a zero magnitude.

20. The vehicle propulsion system of claim 19, wherein the direct component and the quadrature component are estimated in response to a Park transform output, and wherein a magnitude of the direct component is proportional to the AC component superimposed on the DC current, and wherein the first AC current, the second AC current and the third AC current are adjusted to generate a non-zero magnitude of the quadrature component such that the electromagnetic torque has a non-zero magnitude and the AC component has a non-zero magnitude.
